(19) United States
(12) Patent Application Publication
(10) Pub. No.: US 2009/0291351 A1
(43) Pub. Date: Nov. 26, 2009

(54) APPARATUS AND METHOD FOR COATING A PASTE CONTAINING A WATER-REPELLENT SUBSTANCE, AND METHOD FOR MANUFACTURING A FUEL CELL

(76) Inventor: Kazunari Moteki, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/306,275

(22) PCT Filed: Jul. 27, 2007
(86) PCT No.: PCT/IB07/02155

§ 371 Date: Dec. 23, 2008

(30) Foreign Application Priority Data
Jul. 28, 2006 (JP) 2006-206608

(51) Int. Cl. H01M 4/86; B05C 11/00; H01M 4/88

(52) U.S. Cl. 429/40; 118/58; 427/115

(57) ABSTRACT

Making use of the feature that a high polymer is difficult to fiberize when used at below the glass transition point, a pressure-feed device (22) and part of an upstream pipe (26) are covered by a temperature regulation device (128) and the heat exchange in the temperature regulation device (128) maintains the temperature of a paste (PA) containing a water-repellent substance having a glass transition point and that passes through the pressure-feed device (22) to below the glass transition point of the water-repellent substance while coating the paste (PA) from a coating device (24).

### BACKGROUND OF THE INVENTION

1. Field of the Invention

The present invention relates to an apparatus and a method for coating a paste containing a water-repellent substance having a glass transition point, and to a method for manufacturing a fuel cell.

2. Description of the Related Art

There are water-repellent materials that repel water (have a large wetting angle) and hydrophilic materials having an affinity for water (having a small wetting angle), these materials being selectively used in accordance with the application. In order to impart water repellency to a member that does not have intrinsic water repellency, a material exhibiting water repellency is coated onto the surface of the member. In the electrolyte membrane provided in a solid electrolyte type fuel cell, for example, in order to avoid the problem of flooding by the collection of water at the electrode surface, water repellency is imparted to the surface of the electrode by coating the surface with a water-repellent substance. The imparting of water repellency in this manner is generally done by formulating to prepare, for example, a paste made of a water-repellent power or emulsion, and coating or impregnating therewith a member be coated, which is a carbon-based paper or catalyst layer that is to serve as the electrode member of the fuel cell. One type of water-repellent substance is one that has a glass transition point. In particular, polytetrafluoroethylene (hereinafter “PTFE”), because of its high water repellency, is often used in fuel cells. The Japanese Patent Application Publications No. JP-A-2002-367617 and No. JP-A-2001-6699 disclose methods of manufacturing such an electrode containing PTFE.

However, a problem arises such that, if such pastes as the foregoing that contain a water-repellent substance having a glass transition point are pressure-fed to a coating means, for example, a coating gun, by a pressure-feed apparatus, the paste could fiberize, making it difficult to coat. When a water-repellent substance having a glass transition point fiberizes, the paste becomes clay-like, not only preventing uniform coating, but also hindering the drive of the pressure-feed apparatus or the like.

### SUMMARY OF THE INVENTION

The present invention provides an apparatus and a method for coating a paste containing a water-repellent substance having a glass transition point, and a method for manufacturing a fuel cell.

An apparatus according to an aspect of the present invention that coats a paste containing a water-repellent substance having a glass transition point has a coating device that coats the paste onto a member to be coated; a pressure-feed device that pressure-feeds the paste to the coating device; and a temperature regulation device that regulates the paste temperature to a temperature that is below the glass transition point of the water-repellent substance.

The foregoing coating apparatus passes the paste containing the water-repellent substance through the pressure-feed device and performs coating (including impregnation) thereof in a condition of temperature being regulated to be held at a temperature that is below the glass transition point of the water-repellent substance, thereby avoiding problems due to fiberization, even if the paste receives shearing force or the like from the pressure-feed device. It is therefore possible to achieve a superior effect of being able to perform uniform and stable coating of a paste containing a water-repellent substance. The temperature regulation device can be used regardless of the method of cooling. It is possible, for example, to use various heat exchangers using coolants such as water and chlorofluorocarbons (CFCs) or a semiconductor-type cooling devices making use of the Peltier effect, regardless of the operating principle thereof.

In the foregoing coating apparatus, PTFE may be used as the water-repellent substance. While PTFE is often used as a water-repellent substance, for example, as an electrode material in fuel cells, PTFE has a glass transition point of approximately 21° C., and tends to fiberize and cause problems because of shearing force received from the pressure-feed device at temperatures higher than that of the glass transition point. However, by pressure-feeding and coating the paste by a pressure-feed device at a temperature that is lower than approximately 21° C., it is possible to perform uniform, stable coating of the paste while preventing fiberization.

The temperature regulation device of the foregoing coating apparatus may be provided at least at the upstream side of the inlet of the pressure-feed device. Because a paste containing a water-repellent substance having a glass transition point undergoes fiberization by external forces such as the shearing force of the pressure-feed device, it is sufficient, in suppressing fiberization, that the temperature of the paste be below the glass transition point of the water-repellent substance at the point in time that it passes through the pressure-feed device. Thus, by providing the temperature regulation device at the upstream side of the inlet of the pressure-feed device, efficient temperature regulation is possible with only the minimum required temperature regulation locations. Furthermore, to minimize heat loss and regulate the temperature with efficiency, taking into account heat generation in the pressure-feed device, the temperature regulation device may be provided at the outer periphery of the pressure-feed device and at a part of a pipe on the upstream side of the inlet of the pressure-feed device.

In the same manner, the temperature regulation device may be provided either inside or at the outer periphery of a formulating and/or holding device that formulates and/or holds the paste. In this case, sufficient temperature regulation is performed at the paste formulating or holding device disposed further upstream from the pressure-feed device, enabling temperature regulation of the paste to a temperature below the glass transition point of the water-repellent substance, not only in the paste formulating and/or holding device, but also at the point in time at which the paste passes through the pressure-feed device, thereby suppressing fiberization. In addition, even if a stirrer is required for the formulation or making uniform of paste inside at tank of the paste formulating and/or holding device, it is possible suppress fiberization of the paste.

In addition, it is possible to provide the temperature regulation device both at the pressure-feed device and a part of a pipe on the upstream side of the inlet of the pressure-feed device and at the inside or at the outer periphery of the paste formulation and/or holding device. In this case, first, at the temperature regulation device provided at the paste formulating and/or holding device, in order to suppress fiberization of the paste accompanying stirring to formulate or make uniform the paste inside the tank, the paste is held to a temperature that is below the glass transition point of the water-repellent substance. Then, at the temperature regulation device provided at the pressure-feed device and a part of a pipe at the upstream side of the pressure-feed device, cooling is performed commensurate with the rise in temperature of the paste accompanying heat loss in the pipe in transporting the paste up to the pressure-feed device and heat generation in the pressure-feed device, thereby suppressing fiberization of the paste in the pressure-feed device. By performing cooling in this manner in two stages, it is possible to perform efficient temperature regulation throughout the entire process.

The foregoing coating apparatus is effective even in the coating of a paste containing a water-repellent substance having a glass transition point, such as PTFE, onto an electrode member of a fuel cell.

A method for coating a paste according to an aspect of the present invention is a method of coating a paste containing a water-repellent substance having a glass transition point, which regulates the paste temperature to a temperature below the glass transition point of the water-repellent substance and coats the temperature regulated paste by pressure-feeding by a pressure-feed device onto the member to be coated.

According to the foregoing paste coating method, a paste containing a water-repellent substance having a glass transition point is caused to pass through a process step such as a pressure-feed device, at which there is a risk of fiberization caused by a shearing force therefrom, in a condition of temperature being regulated to a temperature that is tower than that of the glass transition point of the water-repellent substance. The result is that, even if a shearing force is applied to the paste, it is possible to suppress fiberization of the water-repellent substance, thereby achieving a superior effect of being able to perform uniform and stable coating of the paste.

In the foregoing coating method, PTFE may be used as the water-repellent substance. PTFE has a glass transition point of approximately 21° C., and tends to fiberize and cause problems because of shearing force received from, for example, the pressure-feed device at higher temperatures than that of the glass transition point. Therefore, by passing and coating the paste by a device such as a pressure-feed device, at which a shearing force is received, at a temperature that is lower than approximately 21° C., it is possible to perform uniform, stable coating of the paste while preventing fiberization.

A method for manufacturing a fuel cell according to an aspect of the present invention is a method for manufacturing a fuel cell including a step of regulating a temperature of a paste containing a water-repellent substance having a glass transition point to a temperature below the glass transition point of the water-repellent substance, a step of coating the paste onto an electrode member and forming an electrode, and a step of assembling a fuel cell using the formed electrode.

According to the foregoing method for manufacturing a fuel cell, a paste containing a water-repellent substance having a glass transition point is caused to pass through a process step such as a pressure-feed device, at which there is a risk of fiberization caused by a shearing force therefrom, in a condition of temperature being regulated to a temperature that is lower than the glass transition point of the water-repellent substance. The result is that, even if a shearing force is applied to the paste, it is possible to suppress fiberization of the water-repellent substance, thereby enabling continuous, stable forming in the manufacturing process.

In the foregoing method for manufacturing a fuel cell, PTFE may be used as the water-repellent substance. PTFE has a glass transition point of approximately 21° C., and tends to fiberize and cause problems because of shearing force received from, for example, the pressure-feed device at temperatures higher than this temperature. Therefore, by passing and coating the paste by an device such as a pressure-feed device, at which a shearing force is received, at a temperature that is lower than approximately 21° C., it is possible to perform uniform, stable coating of the paste while preventing fiberization.

Because the paste coating method according to an aspect of the present invention coats paste containing a water-repellent substance onto an electrode member for a fuel cell while suppressing fiberization, the electrode member for a fuel cell exhibits sufficient water repellency that is both sufficient and uniform.

### BRIEF DESCRIPTION OF THE DRAWINGS

The foregoing and further objects, features, and advantages of the invention will become apparent from the following description of example embodiments with reference to the accompanying drawings, wherein like numerals are used to represent like elements, and wherein:

FIG. 1 is a drawing describing the configuration of a paste coating apparatus as a first embodiment of the present invention;

FIG. 2 is a drawing describing the configuration of a paste coating apparatus as a second embodiment of the present invention; and

FIG. 3 is a process flowchart showing a method for manufacturing a fuel cell according to an embodiment of the present invention.

### DETAILED DESCRIPTION OF THE EXAMPLE EMBODIMENTS

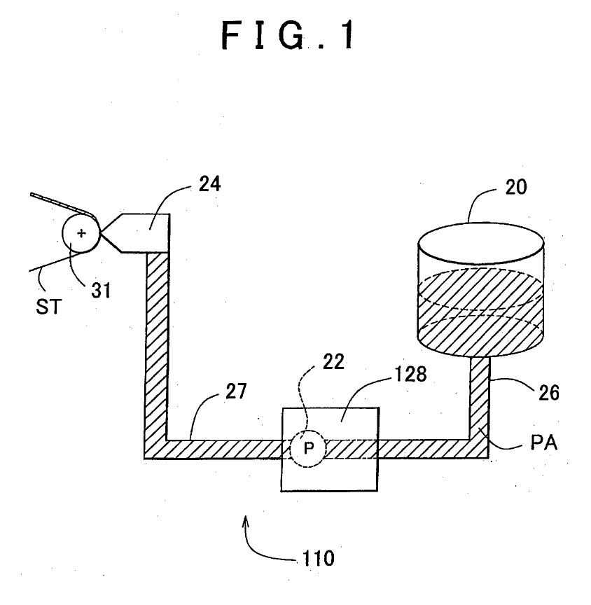

Embodiments of the present invention are described below. FIG. 1 shows the configuration of a coating apparatus 110 according to the first embodiment, which coats a paste containing a water-repellent substance having a glass transition point onto an electrode member of a fuel cell. As shown in FIG. 1, the coating apparatus 110 has a holding tank 20 that holds paste, a pressure-feed device 22 that pressure-feeds the paste, a coating gun 24 that ejects and thinly coats the pressure-fed paste, and a temperature regulating device 128 that cools the pressure-feed device 22 and the like. The holding tank 20 and the pressure-feed device 22 are connected by a pipe 26, and the pressure-feed device 22 and the coating gun 24 are connected by a pipe 27. The pressure-feed device 22 and a part of the pipe 26 upstream of the pressure-feed device are covered by the temperature regulation device 128.

This embodiment uses PTFE as the water-repellent substance, which is made into a paste and held in the holding tank 20 beforehand. This paste is made, for example, by emulsifying and polymerizing a PTFE into a solution beforehand, and mixing the result with a viscosity adjusting agent and carbon black powder. Although it is not illustrated, a stirrer is provided inside the holding tank 20 to stir the paste PA inside the holding tank 20 when coating is performed. The holding tank 20 may serve also as a formulating device that emulsifies the PTFE and that admixes the viscosity adjustment agent and the like.

Because the holding tank 20 is joined to the pressure-feed device 22 via the pipe 26, when the pressure-feed device 22 is operated, paste PA held in the holding tank 20 is transported to the pressure-feed device 22 via the pipe 26, and is further pressure-fed to the coating gun 24 from the pressure-feed device 22. This embodiment uses a piston pump as the pressure-feed device 22. Considering the properties of the PTFE contained in the paste PA, a pressure-feed device of a type having a small shearing force may be used, and it is possible to select a gear pump or a screw pump or the like, in accordance with the viscosity of the paste PA. The coating gun 24 used in this embodiment is a nozzle-type gun capable of discharging the paste PA uniformly from a gap provided at the wide end thereof. The lateral width of the coating gun 24 substantially coincides with the width of the electrode sheet ST that is the member being coated, and an appropriate amount of paste PA is discharged from the gap in the end thereof in synchronization with the transport of the electrode sheet ST by rotation of a roller 31. As a result, a thin, uniform coating film of water-repellent substance is formed on the surface of the electrode sheet ST transported by the rotation of the roller 31. After the solvent evaporates, on the surface of the electrode sheet ST there is formed a coating film made of carbon black, which is electrically conductive, and PTFE, which exhibits water repellency. The coating means may be selected from a variety of types, including one which performs coating by the coating gun 24 moving above a stationary electrode sheet ST, or one which uses not a nozzle but rather a roller made of a porous body to discharge the paste PA. The width of the coating gun 24 and the gap of the nozzle and the like may be selected as appropriate to the shape of the electrode member onto which the paste PA is to be coated, the thickness of the surface water-repellent layer, and the form after coating (for example, formation of a covering film and impregnation).

The temperature regulation device 128 will now be described. The temperature regulation device 128 is a heat-pump type that, by exchange of a coolant between a compressor and radiator (not illustrated) cools the pressure-feed device 22 and the part of the pipe 26 housed therewithin. A thermostat (not illustrated) is provided inside the temperature regulation device 128, the inside of which is cooled to lower than approximately 21° C., and in this embodiment to approximately 15° C. As a result, by indirect heat exchange via the pressure-feed device 22 and the pipe 26, the temperature of the paste PA passing through the pressure-feed device 22 is held to below the glass transition point (approximately 21° C.) of the PTFE, which is the water-repellent substance used in this embodiment. The cooling by the temperature regulation device 128 can be made to maintain a temperature below the glass transition point of the paste PA before the start of pressure-feeding of the paste PA passing through the pressure-feed device 22. The cooling of the paste PA can be done, as in this embodiment, indirectly by cooling of the inside of the temperature regulation device, and can alternatively be done by linking a heat pipe or the like to the pressure-feed device enclosure, gear, or piston, to directly cool, for example, the pressure-feed device 22 or pipe 26. A Peltier effect cooling device may be disposed in the pipe 26 upstream from the pressure-feed device 22 to directly cool the paste PA.

The paste PA that is cooled by the temperature regulation device 128 when it passes through the pressure-feed device 22 passes through the pipe 27 and is coated from the coating gun 24 onto the electrode sheet ST, which will become the electrode member of the fuel cell. In the coating apparatus 110 described herein, PTFE, which is the water-repellent substance contained in the paste PA, does not receive a shearing force by, for example, the pressure-feed device 22 in the temperature region above the glass transition point thereof. The paste PA, therefore, can be coated uniformly and stably onto the electrode member, without the occurrence of fiberization in the process of pressure-feed by the pressure-feed device 22. As a result, the coating apparatus 110 may be incorporated into a process for manufacturing a fuel cell to continuously form an electrode sheet ST. In an apparatus in the related art, when a pressure-feed device is operated to coat a prescribed amount of paste PA, fiberization occurs in the paste PA ejected from the coating gun 24, and it is not possible to perform uniform coating of the paste PA over a long period of time. In contrast, the coating apparatus 110 of this embodiment, even if operated continuously, can suitably form an electrode sheet ST having a coating film of the desired thickness, without the occurrence of lumps (of hardened fiber) on the electrode sheet ST.

According to this embodiment, because the paste PA is cooled by the temperature regulation device 128 to a temperature below the glass transition point of the PTFE contained in the paste PA to avoid fiberization by the shearing force from the pressure-feed device, it is possible to use, in place of a pressure-feed device in the related art having a small shearing force, a pressure-feed device having a relatively large shearing force. Thus, the breadth of selection of the pressure-feed device 22 is increased, thereby providing the advantage of ease of design and operation of the coating apparatus 110.

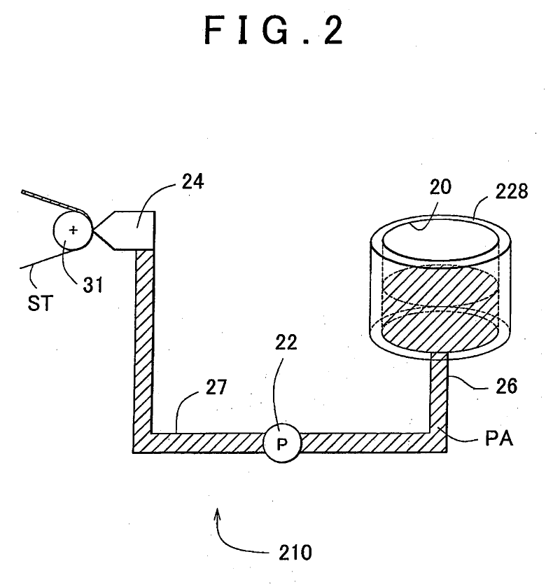

The second embodiment will now be described. FIG. 2 is a drawing showing the configuration of a coating apparatus 210 that coats paste containing a water-repellent substance having a glass transition point onto an electrode member of a fuel cell. The difference in the second embodiment with respect to the first embodiment is that the temperature regulation device 228 is provided at the outer periphery of the holding tank 20, with other elements being the same as the first embodiment. In the second embodiment, by performing sufficient cooling in the holding tank 20 disposed upstream from the pressure-feed device 22, the paste PA passes through the pressure-feed device at a temperature lower than that of the glass transition point of the PTFE, thereby preventing fiberization, and also suppressing fiberization of the paste PA in the case in which it is necessary to stir the paste PA in the holding tank 20 to adjust and make the paste PA uniform. Although in this embodiment the temperature regulation device 228 is provided at the outer periphery of the holding tank 20, the temperature regulation device 228 may be provided at the inner periphery or the inside of the holding tank 20 or at another location at which it is possible to cool the paste PA held in the holding tank 20.

It is further possible to adopt a constitution that combines the constitutions of the first and second embodiments. That is, it is possible to provide the temperature regulation device at the outer periphery of the holding tank 20 and also at the pressure-feed device 22 and part of the upstream pipe 26. In this case, by first maintaining the paste PA in the holding tank 20 at a temperature below the glass transition point of the PTFE, it is possible to suppress fiberization of the paste PA accompanying adjusting and stirring the paste PA for adjustment and uniformity. Further, at the pressure-feed device 22 and a part of the pipe 26 upstream from the inlet of the pressure-feed device 22, by performing cooling commensurate with the rise in temperature of the paste PA accompanying heat loss in the pipe 26 in pressure-feeding up until the pressure-feed device 22 and heat generation in the pressure-feed device 22, fiberization of the paste PA in the pressure-feed device 22 is suppressed. By performing cooling in this manner in two stages, it is possible to perform efficient cooling throughout the entire process.

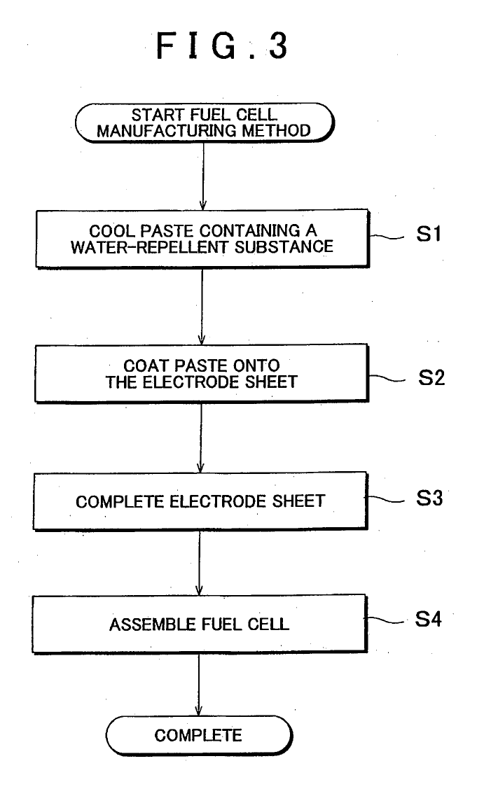

A third embodiment of the present invention is a method for manufacturing a fuel cell. A method for manufacturing in which a paste containing a water-repellent substance having a glass transition point is coated onto an electrode member to manufacture a fuel cell electrode member and a fuel cell will now be generally described. FIG. 3 shows the process of coating an electrode member of a fuel cell with a paste containing a water-repellent substance having a glass transition point to manufacture the electrode member, and also the process of manufacturing a fuel cell. In this embodiment PTFE is used as the water-repellent substance. As shown in the FIG. 3, the fuel cell is manufactured by the following steps. At step S1 the PTFE is emulsified and polymerized into a solution and a paste PA into which a viscosity adjusting agent and carbon black powder are mixed is cooled to below a temperature of approximately 21° C., which is the glass transition point of PTFE (in this embodiment, cooled to 15° C.). At step S2, the cooled PTFE-containing paste PA is coated onto the electrode sheet ST that will become the electrode member of the fuel cell to form a coating film on the surface of the electrode sheet ST. Although the coating is done in this embodiment with the discharge pressure of the coating gun at 3 kPa, the pressure can be appropriately selected in accordance with the shape of the electrode member and the required film thickness. At step S3, the electrode sheet ST onto which is coated the paste PA is dried to evaporate water and solvent, forming a coating film made of carbon black, which is electrically conductive, and PTFE, which exhibits water repellency, thereby completing the electrode sheet ST. At step S4, the manufactured electrode sheet ST is used as an electrode together with separately prepared electrolyte membranes and separators and the like to assemble a fuel cell.

Even if the foregoing method for manufacturing a fuel cell is applied to a continuously operated manufacturing process, it is possible to coat a paste PA containing PTFE onto the electrode sheet ST without the occurrence of fiberization, to manufacture an electrode sheet ST exhibiting sufficient water repellency that is suitable for use in a fuel cell.

Although the present invention is described above by exemplary embodiments, it will be understood that the present invention is not restricted to these embodiments, but can take the form of various embodiments, within the scope and spirit of the present invention. Variations include one in which a temperature regulation device that performs heat exchange with the paste PA via the pipe 26 is provided only in the pipe 26 upstream from the pressure-feed device 22, and one in which a temperature regulation device that performs direct heat exchange with the paste PA is provided midway in the pipe 26.

1. A coating apparatus that coats a paste containing a water-repellent substance having a glass transition point, comprising:
a coating device that coats the paste onto a member to be coated;
a pressure-feed device that pressure-feeds the paste to the coating device; and
a temperature regulation device that regulates a temperature of the paste to a temperature that is below the glass transition point of the water-repellent substance.

2. The coating apparatus according to claim 1, wherein:
the water-repellent substance is polytetrafluoroethylene, and the temperature regulation device regulates the temperature of the paste below 21° C.

3. The coating apparatus according to claim 1, wherein:
the temperature regulation device is provided at least at the upstream side of the inlet of the pressure-feed device.

4. The coating apparatus according to claim 1, wherein:
the temperature regulation device is provided at the outer periphery of the pressure-feed device and at a part of a pipe on the upstream side of the inlet of the pressure-feed device.

5. The coating apparatus according to claim 1, further comprising:
a holding device that formulates and/or holds a prescribed amount of the paste, wherein
the temperature regulation device is provided either inside or at the outer periphery of the holding tank and regulates the temperature of the paste.

6. The coating apparatus according to claim 1, wherein the member to be coated is an electrode member of a fuel cell.

7. A method for coating a paste containing a water-repellent substance having a glass transition point, comprising:
regulating a temperature of the paste to a temperature below the glass transition point of the water-repellent substance; and
pressure-feeding the temperature regulated paste by a pressure-feed device to coat the paste onto the member to be coated.

8. The method for coating according to claim 7, wherein
the water-repellent substance is polytetrafluoroethylene, and the temperature of the paste is regulated below 21° C.

9. A method for manufacturing a fuel cell, comprising:
regulating a temperature of a paste containing a water-repellent substance having a glass transition point to a temperature below the glass transition point of the water-repellent substance;
coating the paste onto an electrode member and forming an electrode; and
assembling a fuel cell using the formed electrode.

10. The method for manufacturing a fuel cell according to claim 9, wherein
the water-repellent substance is polytetrafluoroethylene, and the temperature of the paste is regulated below 21° C.

11. An electrode member for a fuel cell, comprising
a water-repellent substance is coated by a coating method that includes:
regulating a temperature of a paste containing the water-repellent substance having a glass transition point to a temperature below the glass transition point of the water-repellent substance; and
pressure-feeding the temperature regulated paste by a pressure-feed device to coat the paste onto the electrode member for a fuel cell.
